(19) United States
(12) Patent Application Publication
(10) Pub. No.: US 2006/0222037 A1
(43) Pub. Date: Oct. 5, 2006

(54) Semiconductor laser diode

(75) Inventor: Kenji Masuda, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 11/294,555

(22) Filed: Dec. 6, 2005

(30) Foreign Application Priority Data
Apr. 4, 2005 (JP) 2005-107997

(51) Int. Cl. H01S 3/097

(52) U.S. Cl. 372/81

(57) ABSTRACT

A semiconductor laser diode includes a semiconductor cladding layer of a first conductivity type, an active layer on the semiconductor cladding layer of the first conductivity type, a semiconductor cladding layer of a second conductivity type on the active layer, an insulating film on the semiconductor cladding layer of the second conductivity type, a metal electrode electrically connected to the semiconductor cladding layer of the second conductivity type, and an electric circuit element on the insulating film.

### BACKGROUND OF THE INVENTION

1. Field of the Invention

The present invention relates to a semiconductor laser diode that converts an electric input signal into light and outputs the light.

2. Background Art

A semiconductor laser diode is a device that converts an electric input signal into light and outputs the light. Conventionally, an electric circuit element has been disposed outside the semiconductor laser diode in order to optimize the input signal depending on purposes or uses. For example, a terminal resistor is connected in series to a semiconductor laser diode. Although there is an optical modulator to which a terminal resistor is connected in parallel (e.g., refer to Japanese Patent Laid-Open No. 2004-219949), both means and effects differ from those in the case of a semiconductor laser diode.

However, since an electric circuit element is disposed outside, it was difficult downsize the total constitution including the electric circuit element. In addition, there was a problem that the frequency responding characteristics of input signals were deteriorated because of parasitic impedance produced by the connection of the semiconductor laser diode to the external electric circuit element.

### SUMMARY OF THE INVENTION

The present invention has been made to solve foregoing problems, and it is an object of the present invention to provide a semiconductor laser diode that can downsize the total constitution including an electric circuit element, and can reduce parasitic impedance produced by the connection to an electric circuit element to prevent the deterioration of frequency responding characteristics of input signals.

According to one aspect of the present invention, a semiconductor laser diode comprises a semiconductor clad layer of a first conductivity type, an active layer formed on the semiconductor clad layer of a first conductivity type, a semiconductor clad layer of a second conductivity type formed on the active layer, an insulation film formed on the semiconductor clad layer of a second conductivity type, a metal electrode electrically connected to the semiconductor clad layer of a second conductivity type, and an electric circuit element formed on the insulation film.

Other and further objects, features and advantages of the invention will appear more fully from the following description.

According to the present invention, a semiconductor laser diode that can downsize the total constitution including an electric circuit element, and can reduce parasitic impedance produced by the connection to an electric circuit element to prevent the deterioration of frequency responding-characteristics of input signals.

### BRIEF DESCRIPTION OF THE DRAWINGS

FIG. 1 is a perspective view showing a semiconductor laser diode according to the first embodiment of the present invention.

FIG. 2 is a perspective view showing a semiconductor laser diode according to the second embodiment of the present invention.

FIG. 3 is a perspective view showing a semiconductor laser diode according to the third embodiment of the present invention.

FIG. 4 is a perspective view showing a semiconductor laser diode according to the fourth embodiment of the present invention.

### DETAILED DESCRIPTION OF THE PREFERRED EMBODIMENTS

First Embodiment

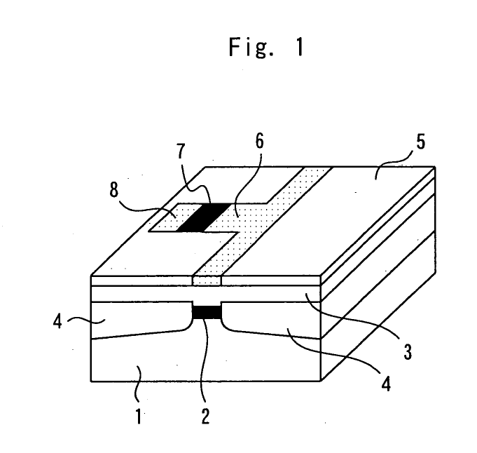

FIG. 1 is a perspective view showing a semiconductor laser diode according to the first embodiment of the present invention.

On a semiconductor clad layer of a first conductivity type 1, an active layer 2 is formed, and a semiconductor clad layer of a second conductivity type 3 is formed thereon. Current block layers 4 are formed on the both sides of the active layer 2, and an insulation film 5 is formed on the semiconductor clad layer of the second conductivity type 3. A metal electrode 6 is formed so as to electrically connect to the semiconductor clad layer of the second conductivity type 3.

Further, in the semiconductor laser diode according to the first embodiment, a resistor 7 is formed on the insulation film 5 as an electric circuit element. The resistor 7 can be formed by the vapor deposition of a thin film. The resistor 7 is electrically connected to the metal electrode 6.

By thus incorporating the resistor 7, no resistors are required to install outside so as to prevent the deterioration of frequency responding characteristics of input signals produced by the mismatch of impedance between the semiconductor laser diode and the drive circuit; therefore, the total constitution including the resistor 7 can be downsized. Further, parasitic impedance produced by the connection to the resistor 7 can be reduced to prevent the deterioration of frequency responding characteristics of input signals. Since optional input impedance can be obtained by using resistors of different resistance, the impedance can be easily matched with the drive circuit.

Second Embodiment

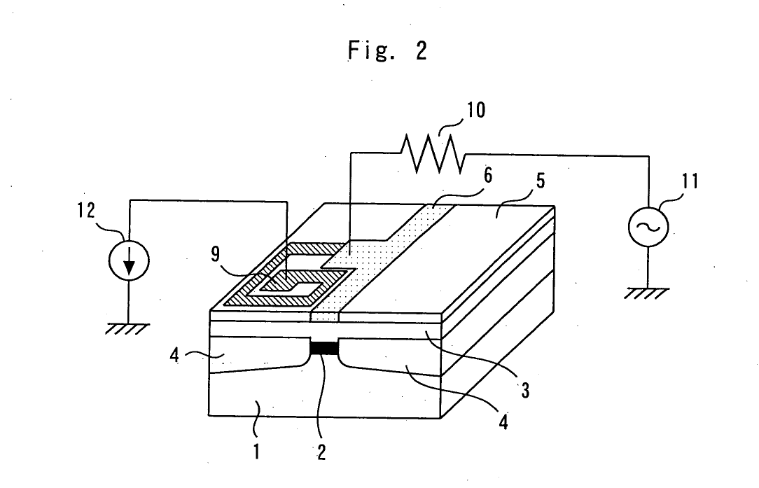

FIG. 2 is a perspective view showing a semiconductor laser diode according to the second embodiment of the present invention. In the semiconductor laser diode according to the second embodiment, an inductor 9 is formed on an insulation film 5 as an electric circuit element. The inductor 9 is electrically connected to the metal electrode 6, and is formed by a spiral pattern of the same composition as the metal electrode 6. Other constitutions are the same as those of the first embodiment.

By thus incorporating the inductor 9, no installation of an inductor that constitute a bias circuit of direct current component for preventing increase in power consumption of the drive circuit and the heat generation of the resistance portion caused by flowing the direct current components in an impedance matching resistor for isolating the direct current component and high frequency (frequency modulation) component of input signals and preventing the deterioration of frequency responding characteristics; therefore, the total constitution including the inductor 9 can be downsized as in the case of the first embodiment 1. Further, parasitic impedance produced by the connection to the inductor 9 element can be reduced to prevent the deterioration of frequency responding characteristics of input signals.

A metal electrode 6 is connected to a pulse generator 11 through a matching resistor 10, and a direct current source 12 is connected to the inductor 9. Thereby the direct current component of input signals can be supplied through the inductor, and the high frequency component of input signals can be supplied without involving the inductor.

Third embodiment

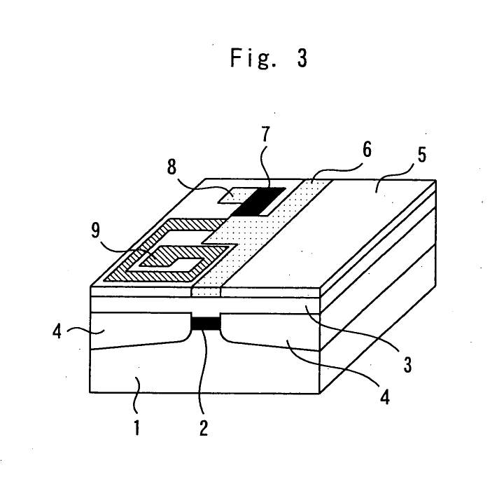

FIG. 3 is a perspective view showing a semiconductor laser diode according to the third embodiment of the present invention. In the first embodiment, only a resistor is formed as an electric circuit element; and in the second embodiment, only an inductor is formed as an electric circuit element. Whereas in the semiconductor laser diode according to the third embodiment, a resistor 7 and an inductor 9 are formed as electric circuit elements on the insulation film 5. Other constitutions are the same as those of the first embodiment. Thereby, the effects of both the first embodiment and the second embodiment can be obtained.

Fourth Embodiment

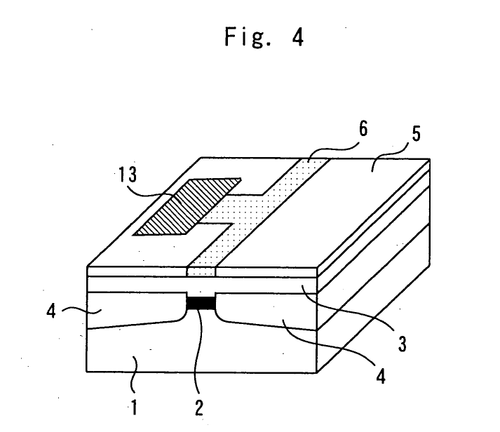

FIG. 4 is a perspective view showing a semiconductor laser diode according to the fourth embodiment of the present invention. In the semiconductor laser diode according to the fourth embodiment, a capacitor 13 is formed on an insulation film 5 as an electric circuit element. The capacitor 13 is electrically connected to the metal electrode 6. The capacitor 13 is composed of a pattern having the same composition of the metal electrode 6 formed in the insulation film 5, a semiconductor clad layer of the second conductivity type 3 having a different potential, and an insulation film 5 interposed between them. Other constitutions are the same as those of the first embodiment.

By thus incorporating the capacitor 13, as in the first embodiment, the total constitution including the capacitor 13 can be downsized, and parasitic impedance produced by the connection to the capacitor 13 can be reduced to prevent the deterioration of frequency responding characteristics of input signals.

Further, a low-pass filter can be composed of the capacitance component of the capacitor and the inductance component of the wire for connecting to the drive circuit, and by truncating unnecessary harmonic components of the input signals, high-purity signals can be transmitted.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2005-107997, filed on Apr. 4, 2005 including specification, claims, drawings and summary, on which the Convention priority of the present application is based, are incorporated herein by reference in its entirety.

1. A semiconductor laser diode comprising:
a semiconductor cladding layer of a first conductivity type;
an active layer formed on the semiconductor cladding layer of the first conductivity type;
a semiconductor cladding layer of a second conductivity type formed on the active layer;
an insulating film on the semiconductor cladding layer of the second conductivity type;
a metal electrode electrically connected to the semiconductor cladding layer of the second conductivity type; and
an electric circuit element on the insulating film.

2. The semiconductor laser diode according to claim 1, wherein the electric circuit element is electrically connected to the metal electrode.

3. The semiconductor laser diode according to claim 1, wherein the electric circuit element is a resistor.

4. The semiconductor laser diode according to claim 2, wherein the electric circuit element is a resistor.

5. The semiconductor laser diode according to claim 1, wherein the electric circuit element is an inductor.

6. The semiconductor laser diode according to claim 2, wherein the electric circuit element is an inductor.

7. The semiconductor laser diode according to claim 1, wherein the electric circuit element is a capacitor.

8. The semiconductor laser diode according to claim 2, wherein the electric circuit element is a capacitor.
